(19) United States
(12) Patent Application Publication
(10) Pub. No.: US 2018/0017392 A1
(43) Pub. Date: Jan. 18, 2018

(54) APPARATUS, SYSTEM, AND METHOD FOR TRAFFIC

(71) Applicant: KING ABDULLAH UNIVERSITY OF SCIENCE AND TECHNOLOGY, Thuwal (SA)

(72) Inventors: Christian CLAUDEL, Thuwal (SA); Mustafa MOUSA, Thuwal (SA); Mohammed ABDULAAL, Thuwal (SA)

(73) Assignees: KING ABDULLAH UNIVERSITY OF SCIENCE AND TECHNOLOGY, Thuwal (SA); KING ABDULLAH UNIVERSITY OF SCIENCE AND TECHNOLOGY, Thuwal (SA)

(21) Appl. No.: 15/546,200

(22) PCT Filed: Feb. 21, 2016
(86) PCT No.: PCT/IB2016/000259

§ 371 Date: Jul. 25, 2017

Related U.S. Application Data
(60) Provisional application No. 62/119,094, filed on Feb. 20, 2015.

(51) Int. Cl. G01C 21/18; G08G 1/01; G01C 23/00; G01C 21/32; H04W 4/02; H04W 4/04; H04W 84/18

(52) U.S. Cl. CPC G01C 21/18; G01C 23/00; G08G 1/0112; G01C 21/32; H04W 4/046; H04W 84/18; H04W 4/027

(57) ABSTRACT

An apparatus, system, and method for traffic monitory can have a Lagrangian inertial measurement unit. The Lagrangian inertial measurement unit can have a processor, an accelerometer, a gyroscope, and/or a wireless transmitter. The processor can have an integrated direction cosine matrix. The accelerometer can be configured to measure linear accelerations of a vehicle and/or can communicate measured linear acceleration to the processor. The gyroscope can be configured to measure rotational accelerations of the vehicle and/or can communicate measured rotational acceleration to the processor. The processor can be configured to calculate estimated vehicle speed and/or estimated vehicle attitude. The wireless transmitter can be configured to wirelessly transmit estimated vehicle speed and/or estimated vehicle attitude. The apparatus, system, and method can be integrated with a wireless sensor network.

### CLAIM OF PRIORITY

This application claims priority to U.S. Provisional Patent Application No. 62/119,094, filed Feb. 20, 2015, which is incorporated by reference in its entirety.

### FIELD OF THE INVENTION

This invention relates to efficiently and reliably monitoring traffic and more particularly relates to inertial measurement devices, wireless networks, and related methods such as for the operation of the inertial measurement devices, for the operation of wireless networks, and for Lagrangian measurements of traffic.

### BACKGROUND

Traffic sensing systems have traditionally included fixed sensor-based traffic sensing systems such as camera-based systems, loop detector based systems, ultrasonic rangefinder systems, and magnetometer systems. In the past decade, probe-based sensing systems have been used to generate traffic maps. Prior art probe-based traffic sensing systems use either satellite-based location systems or triangulation/trilateration/time of flight measurements of cellphone data. Examples of probe-based systems include the Mobile Millennium system, GPS-equipped fleet vehicles, and cellphone location tracking. However, these sensing methods are not without drawbacks, such as cost.

### SUMMARY

An aspect can include a Lagrangian inertial measurement unit system, which can have one or more inertial measurement units and/or one or more wireless sensor nodes. An inertial measurement unit can be attached to a vehicle and can have a wireless transmitter and/or a processor. The processor can be connected to an accelerometer, a gyroscope, and/or a magnetometer. The accelerometer can be configured to measure linear accelerations of a vehicle and/or can communicate measured linear acceleration to the processor. The gyroscope can be configured to measure rotational accelerations of the vehicle and/or communicate measured rotational acceleration to the processor. An optional magnetometer can be used for various measurements, such as for dead reckoning and/or heading fixes. The processor can have a direction cosine matrix complementary filter and/or can be configured to output estimated vehicle speed and/or estimated vehicle attitude. The wireless transmitter can be configured to wirelessly transmit estimated vehicle speed and/or estimated vehicle attitude. Each of the plurality of wireless sensor nodes can have a microcontroller platform, a node processor, and/or a transceiver. The transceiver can be configured to receive estimated vehicle speed and/or estimated vehicle attitude and communicate the estimated vehicle speed and the estimated vehicle attitude to the node processor. The node processor can be configured to estimate vehicle trajectory based on estimated vehicle speed and/or on estimated vehicle attitude and can be further configured to communicate estimated vehicle trajectory to the transceiver. The transceiver can be further configured to transmit estimated vehicle trajectory to other wireless sensor nodes and can be further configured to receive other estimated vehicle trajectories from other wireless sensor nodes.

Some embodiments can further include a processor further configured to output compressed data based on estimated vehicle speed and/or on estimated vehicle attitude. The processor can estimate vehicle speed and/or estimate vehicle attitude, e.g., via a piecewise linear trajectory approximation of linear acceleration and/or rotational acceleration.

In some embodiments, wireless sensor nodes can be configured to associate location fix data with estimated vehicle trajectory. The Lagrangian inertial measurement unit system can be configured to geographically map traffic conditions based on, e.g., location fix data and estimated vehicle trajectory.

Another aspect can include a Lagrangian inertial measurement unit. The Lagrangian inertial measurement unit can have a processor, an accelerometer, a gyroscope, and/or a wireless transmitter. The processor can have an integrated direction cosine matrix. The accelerometer can be configured to measure linear accelerations of a vehicle and/or can communicate measured linear acceleration to the processor. The gyroscope can be configured to measure rotational accelerations of the vehicle and/or can communicate measured rotational acceleration to the processor. The processor can be configured to calculate estimated vehicle speed and/or estimated vehicle attitude. The wireless transmitter can be configured to wirelessly transmit estimated vehicle speed and/or estimated vehicle attitude.

In some embodiments, the processor can be further configured to calculate compressed data based on, e.g., measured vehicle speed and/or measured vehicle attitude. The processor can be further configured to obtain compress calculations via a piecewise linear trajectory approximation subcomponent. Embodiments can further have a plurality of wireless sensor nodes. Each of the plurality of wireless sensor nodes can have a microcontroller platform, a node processor, and/or a transceiver.

In other embodiments, the transceiver can be configured to receive compressed data and/or communicate compressed data to a node processor. The node processor can be configured to estimate vehicle trajectory based on, e.g., compressed data. The transceiver can be further configured to transmit estimated vehicle trajectory to other wireless sensor nodes and/or to receive other estimated vehicle trajectories from the other wireless sensor nodes.

Yet other embodiments can include a plurality of wireless sensor nodes. Each of the plurality of wireless sensor nodes can include a microcontroller platform, a node processor, and/or a transceiver.

In another aspect a Lagrangian inertial measurement method can determine traffic conditions and can have steps for measuring linear accelerations, measuring rotational accelerations, filtering measured linear and/or rotational accelerations, estimating vehicle speed and attitude, wirelessly transmitting estimated vehicle speed and estimated vehicle attitude to a fixed node of a wireless sensor network; and calculating an estimated vehicle path. The measuring steps can be performed with an accelerometer, e.g. for measuring linear accelerations of a vehicle, and/or with a gyroscope, e.g. for measuring rotational accelerations of the vehicle. Filtering can be performed with a direction cosine matrix complementary filter, processing measured linear accelerations and/or measured rotational accelerations, to obtain filtered speed and attitude data. Estimating vehicle speed and/or vehicle attitude can be based on filtered speed and attitude data. Estimated vehicle speed and/or estimated vehicle attitude can be wirelessly transmitted to a fixed node of a wireless sensor network.

In some embodiments, calculating estimated vehicle path can further include periodically fixing headings. In other embodiments, calculating estimated vehicle path can further include performing periodic map-matching to reconstruct vehicle trajectory. Either embodiment can further include performing piecewise linear approximation of estimated vehicle path. In addition, or alternatively, the method can further include an optimization of estimated vehicle path to determine actual vehicle path.

In other embodiments, a transceiver of the fixed node can receive estimated vehicle speed and/or estimated vehicle attitude. The transceiver can communicate estimated vehicle speed and/or estimated vehicle attitude to a node processor. The node processor can estimate vehicle trajectory based on, e.g., estimated vehicle speed and/or on estimated vehicle attitude. The node processor can also or alternatively communicate estimated vehicle trajectory to the transceiver. The transceiver can transmit estimated vehicle trajectory to other wireless sensor nodes of the wireless sensor network.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 depicts an exemplary microcontroller platform.

FIG. 2 illustrates an exemplary system embodiment and methods implemented by the system.

FIG. 3 illustrates attitude angles of a vehicle.

FIG. 4 graphically illustrates pitch derived from a gyroscope and pitch estimated by and exemplary APM utilizing a direction cosine matrix algorithm described herein.

FIG. 5 illustrates an exemplary dead reckoning system and algorithm.

FIG. 6 illustrates a route in a vehicle-frame of reference.

FIG. 7 graphically illustrates a piecewise linearization of a complete trajectory and optimized segments obtained from a piecewise linear optimization.

FIG. 8 depicts an exemplary implementation, provided only for illustrative purposes.

FIG. 9 depicts (a) the path of a test drive and (b) locations of fixed wireless network nodes along the path.

FIG. 10 graphically illustrates raw data from an IMU.

FIG. 11 graphically depicts estimated trajectory based on dead reckoning and a GPS plot over a map.

FIG. 12 graphically illustrates an estimated speed map compared to a GPS speed map.

FIG. 13 schematically illustrates an IMU device, system, and method of some embodiments.

FIG. 14 depicts an exemplary system embodiment.

FIG. 15 depicts a traffic- and environment-sensing node that can be integrated with some system embodiments.

### DETAILED DESCRIPTION

Apparatus, system, and method embodiments for inertial measurement unit-based traffic monitoring using short range wireless sensor network are described. Various features and advantageous details are explained more fully with reference to the non-limiting embodiments that are illustrated in the accompanying drawings and detailed in the description. Descriptions of well-known known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Probe vehicle data is often generated using satellite navigation systems such as the GPS, GLONASS, or Galileo systems. However, because of high cost, relatively high positional uncertainty, and low sampling rates, satellite positioning systems can have a relatively low penetration rate among users. To address these and other issues, embodiments herein can be implemented for traffic monitoring based on inexpensive inertial measurement units in conjunction with a wireless sensor network deployed inside a city. In addition to sensing techniques, some system embodiments can use an open source robotic platform as described herein. Such systems can be used to generate traffic measurement data.

Traffic sensing systems and methods based on a combination of fixed sensor data and probe vehicle data are not without drawbacks that can be addressed utilizing embodiments herein. In particular, the cost and the power consumption of prior systems, such as GPS, can be relatively high. GPS-based systems can become much less accurate within cities due to, e.g., multi-path effects and/or RF fading, which can affect the ground speed measurements. And, prior probe-based systems use either satellite-based location systems or cellular-location data, which can be much less accurate than fixed sensor systems. In addition to multipath effects or RF fading effects that can add uncertainty in positioning, vehicles stopping for reasons unrelated to traffic congestion—for instance to drop a passenger or buy something—can require many sensors than would generally be acceptable for highway traffic. Present embodiments can eliminate this issue because, e.g., the accelerometer and gyroscope can recognize the context associated with sensing and eliminate or provide context to the corresponding measurements. For example, if a vehicle parks, which is associated with significant rotation along the vertical axis, the measurement can be eliminated. And, stop and go traffic can be recognized by acceleration patterns detected by the accelerometer and/or gyroscope and can sent to the traffic estimation servers to distinguish such situations from, e.g., waiting at a traffic light. Present embodiments utilizing Lagrangian traffic sensing techniques described herein can greatly improve the quality of traffic sensing and can provide road condition measurements as a secondary benefit.

Probe traffic data can include GPS data, generated, e.g., whenever a vehicle equipped with such a system has a clear line of sight. GPS can provide location with accuracies ranging from tens of meters to tens of centimeters, depending primarily on the type of GPS receiver. GPS, however, can often be unavailable, especially in urban areas because of the urban canyon effect, brought on by a reduced number of visible satellites. Even when sufficient GPS satellites are available, accuracy can suffer from multi-path effects.

Dead reckoning can be used to estimate the position of a vehicle using, e.g., an inertial measurement unit (IMU). Due to much lower complexity than GPS systems, IMUs can be less expensive. They can also be immune to environmental noise effects, in particular to multi-path effects encountered in cities, or to GPS jammers or spoofers that can be procured relatively easily. IMUs can be extremely good at detecting and classifying types of traffic congestion, distinguishing between traffic lights, stop and go waves, slow traffic, and continuous traffic. This can be achieved because of, for example, high accuracy of IMUs over short time windows.

IMU devices, by themselves, are generally unable to give absolute position measurements. Nevertheless, IMUs can be used in environments in which a vehicle or device periodically estimates position using, e.g., an absolute position measurement. A network of short range radio sources can be utilized as fixed locators in a positioning system. Ordinary techniques know, for example, in the aeronautical navigation arts can be utilized, for example as used in navigation systems of commercial airplanes. Such systems can use high accuracy inertial measurements in conjunction with fixed ground beacons to estimate the location of airplanes. In some of the present embodiments, inaccuracy of the low-cost IMUs can be compensated by, e.g., path estimation algorithms. Such algorithms can use local network topology to infer paths taken by cars as well as conditions experienced on each link. These embodiments can result in systems significantly less expensive than an all-GPS system because of, e.g., the lower cost of IMU chips over GPS chips and can be immune to noise or the spoofing that GPS can suffer from. Such embodiments can thereby be more reliable. In addition, the system can offer strong guarantees for the privacy of participating users.

Although costs or other consideration of a GPS can make a standalone IMU preferable in some embodiments, the devices can additionally contain an absolute positioning unit (APU) such as a GPS unit and/or other APUs such as Galileo, Glonass, and/or other systems. Such combination systems, e.g. GPS-IMU systems, can provide several advantages. For example, an APU-IMU system can provide context in traffic measurement sensing data. An APU-IMU system can filter outliers, such as when a car pulls over and stops. An APU-IMU system can detect the length of a queue at a traffic light or stop sign. In such embodiments a wireless sensor network can be dispensed with or simply ignored because such devices can communicate data wirelessly, e.g., to a cellphone node such as according 3G and/or 4G standards.

Embodiments herein can infer vehicle paths and estimate local traffic velocity to generate accurate traffic maps given a set of vehicles equipped with IMUS and an associated fixed wireless sensor network located. The systems and methods can be scalable, implemented through low-power nodes, and can be computationally efficient and reliable.

Traffic sensing systems and methods can utilize a new type of sensing paradigm based on a short range wireless sensor network used in conjunction with probe vehicles transmitting data to nodes of the fixed sensor network whenever in range. The wireless sensor network approach can offer strong privacy guarantees for probe users unlike existing systems. Traffic conditions can be locally inferred using nodes of the fixed wireless sensor network. The wireless sensor network approach can increase the reliability of the system over, e.g., server-based approaches, can reduce the total cost of the system since, e.g., the cost of IMU chips and short range ad-hoc transceivers is generally much lower than the cost of GPS chips and cellphone data transceivers, and can preserve user privacy.

Components of an exemplary system embodiment can include vehicular subcomponents and fixed wireless sensor network subcomponents. By way of example to a person having ordinary skill in the art, exemplary vehicular subcomponents can include an Ardupilot Mega (APM) v2.6 microcontroller and a number of sensors that are attached to a vehicle to gather data. For example, the sensors can be magnetometers, GPS devices, and/or IMUS disposed on or in a dashboard or under a hood. Firmware for the exemplary APM can be, e.g., Arduplane, which is an open source software used for unmanned aerial vehicle autopilots. On board processing can be performed by the APM processor, e.g. an Atmel ATMEGA 2560 8-bit chip with 256 KB flash memory and a maximum operating frequency of 16 MHz. Such a platform can perform a large number of processes related to guidance and attitude estimation, i.e. yaw, pitch and/or roll angles, using a direct cosine matrix complementary filter as discussed herein.

By way of further example to a person having ordinary skill in the art, exemplary fixed wireless sensor network subcomponents can include four fixed sensor nodes per square kilometer. Each sensor node can include a microcontroller platform, for example microcontrollers based on an ARM Cortex M4 processor operating at 168 MHz, which can be sufficient for processing required in trajectory estimation algorithms described herein. FIG. 1 depicts an exemplary 32-bit microcontroller platform. The platform as depicted is a 9cm x 6.5cm XBee module. Specifically, the platform has an XBee-802.15.4-Pro transceiver module having a sufficient data rate to exchange trajectory data in a fraction of a second. A data compression scheme discussed herein can further further reduce the required bandwidth.

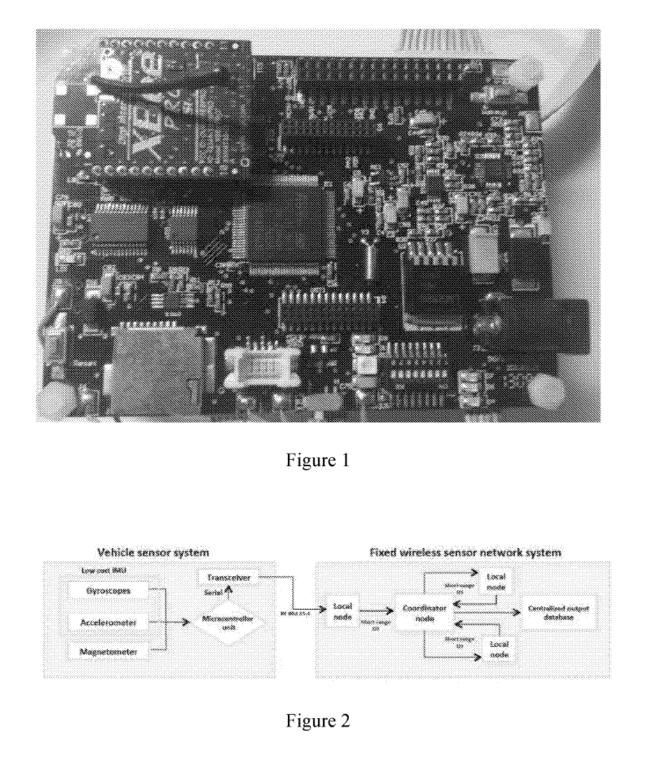

FIG. 2 illustrates an exemplary system embodiment. In the exemplary system, traffic data from IMUs can be processed within the fixed wireless sensor network, which can compute traffic maps using distributed computing. Resulting traffic maps can be forwarded to an output database.

Trajectory can be reconstructed from inertial measurements of the IMUs. For example, computation of the acceleration of the vehicle can be performed in the Earth's frame of reference, which can include computation of attitude angles such as the pitch and the roll of the vehicle. Attitude angles such as pitch and roll can be calculated through, for example, estimation algorithms. A direction cosine matrix (DCM) can be used in attitude estimation and control of ground or air vehicles. An estimation algorithm that can be utilized for some embodiments can be performed by an accelerometer that can measure gravity minus acceleration. Acceleration is a sum of all of aerodynamic forces, e.g. down force, drag, etc., and ground forces on the vehicle, e.g. normal force, friction force, plus gravity divided by mass. The accelerometer can measure the opposite of the total of all non-gravitational forces, i.e. ground and aerodynamic forces. A measurement of gravity can be utilized to estimate the attitude of the vehicle. But since the vehicle can accelerate, acceleration is not generally measured directly. In particular, when the vehicle pitches up or down from, e.g., road characteristics, it briefly accelerates in such a way that the output of an accelerometer generally does not change.

Orientation sensing devices such as gyroscopes can be used as primary sources of orientation information. Nonlinear differential kinematic equations can be utilized to relate time rates of change in orientation of a vehicle to its rotation rate and therewith integrate a present orientation. Numerical errors in such integrations can gradually violate orthogonality constraints that a DCM must satisfy. But, small regular adjustments to the elements of the matrix can be made to satisfy such constraints.

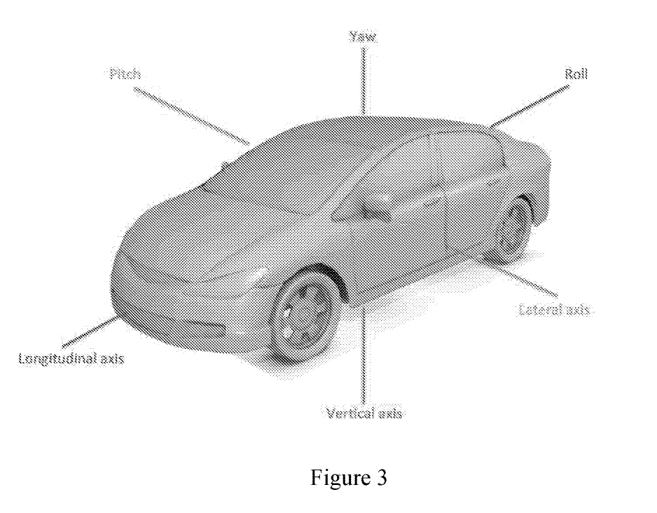

Calculating attitude angles can include a DCM complementary filter. A description of exemplary methodology is discussed in a publication by Premerlani and Bizard, “Direction Cosine Matrix IMU: Theory (2009), which can be accessed online via http Internet site diydrones.com/profiles/blogs/dcm-imu-theory-first-draft?id=705844, the entirety of which is incorporated herein by reference. Attitude angles roll (φ), pitch (θ), and yaw (ψ) and their corresponding axes are illustrated in FIG. 3.

Accelerometer data can be used to compute reference vectors. A DCM filter can use reference vectors to detect errors to dissipate the errors faster than they can build up. A proportional plus integral (PI) and a negative feedback controller can be also or alternatively be used to detect errors, e.g., between the detected errors and the gyroscopes inputs.

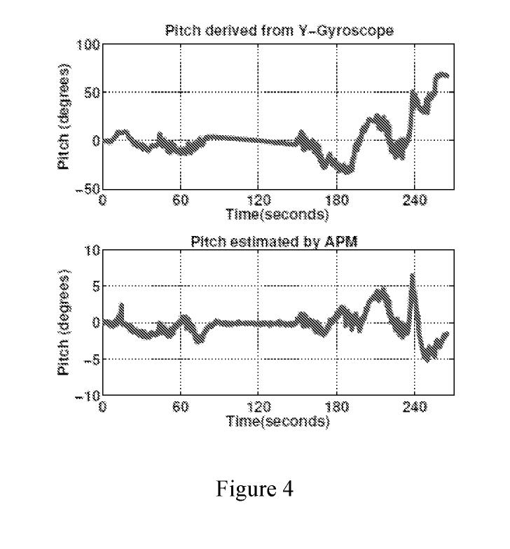

Pitch and/or roll angles can be derived from a DCM complementary filter can be used to correct acceleration measurements generated by an IMU. A vehicle system can detect accelerations when it pitches up or down, as well as when it rolls left or right, and these accelerations need not translate in a physical-kinematic-acceleration of the car. While the attitude can be logically inferred from gyroscopes measurements only, for example because gyroscopes detect rotation rates on all three axes, integrating these measurements can lead to diverging results. FIG. 4 illustrates such diverging results.

As can be seen in FIG. 4, gyroscope measurement integration can leads to diverging results, whereas the DCM complementary filter can yield stable results. The top graph of FIG. 4 shows the pitch, θ_{Gyro}, derived from a gyroscope reading in the Y-direction. The bottom graph of FIG. 4 shows the pitch, θₐₘₚ, estimated by an APM using a direction cosine matrix algorithm discussed herein. The DCM complementary filter can correct the integration process using the acceleration measurements, which in the long term are pointed towards the center of the earth.

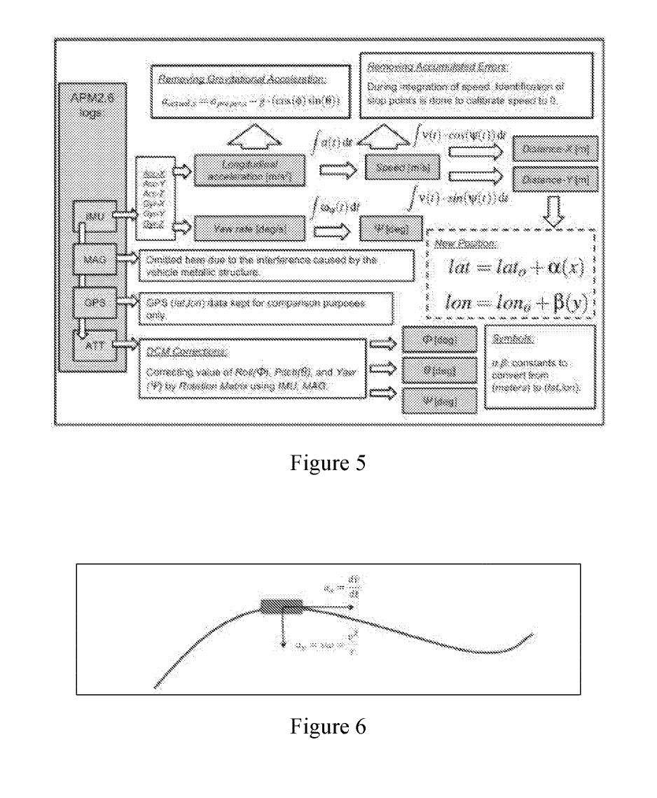

Dead reckoning can be described as a process of determining the position of an object by projecting course and speed from a known past position. A general method for dead reckoning can is illustrated in FIG. 5. Input data from an APM system is represented in the leftmost gray box, and the output data (longitude and latitude) is outlined by a dashed box. Various present embodiments can include, beyond mere dead reckoning, estimating vehicle trajectory based on a final position and on measurements of accelerations and of rotation rates on the vehicle's path. As discussed herein, data output of an APM can be in the form of sampled data at, e.g., 50 Hz, where acceleration can be expressed in meters per second-squared (m/s²) and the angular velocity vector can be measured in degrees per second (deg/s). Angular velocity vector directly translates the rotation rates of the car around its three axes. But, the acceleration vector need not directly represent the acceleration of the vehicle along these axes because accelerometers generally measure proper acceleration, e.g. acceleration of a car with respect to a free falling frame.

In the frame of the vehicle, the acceleration, aₚᵣₒₚₑᵣ, can be measured by the accelerometer (modulo some noise). Thus, the actual acceleration, a_{actual}, of the vehicle in the vehicle-frame can be expressed:

\vec{a}_{actual}=\vec{a}ₚᵣₒₚₑᵣ−\vec{g} (1)

where \vec{g} is the gravity vector of coordinates (0, 0,−g) in the earth frame. FIG. 6 shows acceleration coordinate vectors of a vehicle frame on the map, where r is the radius of the curvature of the trajectory. Projecting equation (1) on the longitudinal and lateral axes of the vehicle, x and y respectively, yields:

a_{actual,x}=a_{proper,x}−g·(cos(φ)sin(θ)cos(ψ)+sin(φ)sin(ψ)) (2)

a_{actual,y}=a_{proper,y}−g·(cos(φ)sin(θ)sin(ψ)+sin(φ)cos(ψ)) (3)

It can be assumed that ψ=0, i.e. that g is always parallel to the z-plane, yielding:

a_{actual,x}=a_{proper,x}−g·(cos(φ)sin(θ)) (4)

a_{actual,y}=a_{proper,y}−g·(−sin(φ))=a_{proper,y}g·sin(φ) (5)

Acceleration in a body-frame moving horizontally can be represented by two classical kinematic components,

$$a = ( \frac{dv}{dt} , \frac{{v}^{2}}{r} ) ,$$

where

$$\frac{dv}{dt}$$

is a rate of variation of velocity, e.g. the speed of a vehicle, and

$$\frac{{v}^{2}}{r}$$

corresponds to a lateral acceleration component that can depend on the radius of curvature, r, of its trajectory. For mapping the trajectory of a vehicle, present embodiments can generally assume trajectories in a two-dimensional plane of axes X and Y.

Based on the above alone, trajectory can be logically inferred directly from the longitudinal and lateral acceleration measurements. Vehicles turn at relatively low speeds for low cost IMUs of some preferred embodiments, which can result in low accuracy of lateral acceleration measurements for estimating rotation rate, ω_{ψ}=r/v. Nevertheless, the z-component of rotation rate vector can be obtained from gyroscope measurements, which are the derivative of the heading of the vehicle and corresponds to the rotation rate ω_{ψ}=r/v modulo some noise.

The magnitude of vehicle speed can be determined from the integral of

$$\frac{dv}{dt} ,$$

i.e. of the x-component of the acceleration. Therefore,

v(t)=a(t)·Δt+v(t−1) (6)

This numerical integration process can diverge without periodic velocity measurements due to sensor noise and integration errors. Present embodiments can address this by taking advantage of vehicles frequently stopping, which is particularly advantageous in cities for reasons discussed herein. Accelerometer and/or gyroscope measurements can detect whenever a vehicle is stopped, and vehicle velocity can be reset to zero.

An IMU can provide key data at stopping points. For example, angular rates are nearly zero, and acceleration is nearly constant on all axes. For further example, longitudinal acceleration measured before a stopping point is negative, i.e. the car is decelerating. Stopping points can be distinguished from, for example, substantially constant speeds experienced along flat highways. Embodiments can advantageously implement algorithms designed to periodically correct speed estimates. For example, embodiments have been implemented with the exemplary algorithm illustrated in Table 1, presented as pseudo code for a speed integration algorithm.

TABLE 1

```
for duration of the experiment do
    if acceleration(t)<AccGain and Gyroscope(t)<GyroGain then
      increment counter
      if counter equals 1 then
          MarkThisPoint ← t
      end if
    else
      reset counter to zero
    end if
    if counter > TimeGain then
      if acceleration at MarkThisPoint < 0 then
          increment counter of stops
          arrayStops(CounterOfStops) ← t
      end if
    end if
end for
for duration of the experiment do
    Speed (t) ← Accₓ (t) · Δt + Speed (t − 1)
    for number of stop points detected do
      if t equals any of the stops then
          Speed(t) ← 0
      end if
    end for
end for
```

More advanced correction schemes can be utilized since, for example, the velocity is not necessarily needed in real time. Similarly, the yaw angle, yr, can be calculated by integrating gyroscope angular velocity measurements in the z-axis with respect to time:

v(t)=ω_{ψ}(t)·Δt+ψ(t−1) (7)

Equation (7), similarly to other cases, can lead to diverging results.

Various methods can be utilized to address diverging results. For example, a periodic heading fix can be implemented using an instrument built into the IMU device, such as a magnetometer. Advantageously, off-the-shelf IMU chips can be found for little cost that have integrated accelerometers, gyroscopes, and magnetometers, such as iNEMO-Inertial Modules from STMicroelectronics. As a person having ordinary skill in the art will recognize, magnetometers disposed in vehicles generally need attention paid to the magnetic effects of the large amounts of metal in the vehicle, but this can be addressed without undue engineering. For another example, map-matching can be implemented to reconstruct vehicle trajectory. Local road network topology can constrain possible paths of the vehicle, which can advantageously be taken into consideration. A next step can be obtaining an estimated path from velocity and heading estimates. Since a vehicle can generally be assumed to be moving on a two dimensional plane (X, Y), its position can be described by:

x(t)=v(t)·cos(ψ(t))·Δt+x(t−1) (8)

y(t)=v(t)·sin(ψ(t))·Δt+y(t−1) (9)

Compressing estimated vehicle trajectory before sending it to a fixed wireless network can be advantageous for operating in dense urban environments where large numbers of probe vehicles can be monitored. Linear trajectory can be approximated piecewise to keep key features of the trajectory while minimizing the amount of data transmitted to fixed sensor nodes. Piecewise linear approximation can reconstruct trajectory by using a relatively small number of linear components. One way of viewing a piecewise linear approximation is as a nonlinear constrained optimization problem, which can be stated as follows.

An objective of the constrained optimization problem can be to find the values of the break points for N data points of (x, y) measurements, i.e. along the x- and y-axes, in which can be obtained new segments f_{j,i}_{_{fitted}} (x, y)—where j is from 1 to −1, m is the number of end points of the segments, i is from 1 to nⱼ; and nⱼ is the number of data points in the j^{th} segment—and where

k₁≦f_{j,i}_{_{fitted}}(x, y)<kₘ

where k₁ and kₘ are beginning and end points of a position vector on the x-axis(x) in which kⱼ represents the j^{th} interior knot with coordinates (xⱼ, yⱼ). An objective function to be minimized is can be represented as

$${min}_{{x}_{1} , {y}_{1} , … , {x}_{m} - 1 , {y}_{m} - 1} {\sum }_{j = 1}^{m - 1} {\sum }_{i = 1}^{{n}_{j}} \vert {f}_{j , {i}_{actual}} ( x , y ) - {f}_{j , {i}_{fitted}} ( x , y ) \vert \qquad ( 10 )$$

where f_{j,i}_{_{fitted}} (x, y) is the fitted piecewise linear function (segmentation) of f_{j,i}_{_{actual}} (x, y), which represents the actual position of the trajectory along the x- and y-axes, given a number of end points, m.

Some embodiments herein can utilize linear interpolation between two break points, which can be represented as

$${f}_{j , {i}_{fitted}} ( x , y ) = ( x , {y}_{j} + \frac{{y}_{j + 1} - {y}_{j}}{{x}_{j + 1} - {x}_{j}} ( x - {x}_{j} ) ) , \qquad ( 11 )$$

where j=1, . . . , m−1 is the segment index of m−1 segments fitting a given trajectory (xᵢ, yᵢ). The coordinates (xᵢ, yᵢ) in the (x, y) plane of the first break point (i.e. left end) of the j^{th} segment, i.e. kⱼ, and (xⱼ₊₁, yⱼ₊₁) are the (x, y) coordinates of the second break point (i.e. right end) of the j^{th} segment, i.e. kⱼ₊₁. Constraints can be imposed so that no pair of knots lies too closely together and so that knots lie in increasing order but still lie inside the first and final knots. Various methods can be employed to find the minimum of this constrained optimization problem. As an example to a person having ordinary skill in the art, the optimization problem can be solved by using the fmincon function in Matlab's optimization toolbox. This function can find optimized interior knots by finding the minimum of a constrained nonlinear multivariable function, for example the x and y position variables, starting at an initial estimate with all the knots equally spaced. See, for example, MathWorks' documentation page for the “fmincon” function on the World Wide Web at www.mathworks.com/help/optim/ug/fmincon.html, which is incorporated herein by reference in its entirety.

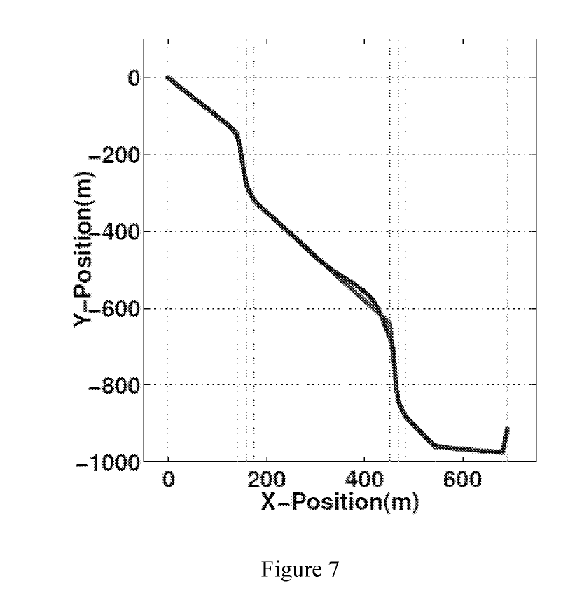

FIG. 7 shows the result of the piecewise linearization of a path estimated by a dead reckoning algorithm. The implemented embodiment utilized ten break points, with eight interior knots and nine segments, to optimize distances between (x, y) measurements to the (x, y) coordinates used in the fitting, i.e. m=10 and k₂, . . . , k₉. The black curve shows the result of piecewise linearization of the complete trajectory estimated by the dead reckoning algorithm. The gray curve shows the estimation found utilizing present embodiments of the dead reckoning algorithms, and the dashed lines show the optimized segments obtained from the piecewise linear optimizer.

By way of further illustrating aspects of various embodiments to a person having ordinary skill in the art, and not a limitation of any particular embodiment, an implementation is discussed. Moreover, the exemplary implementation was configured merely for data acquisition purposes. An objective of the exemplary implementation is to estimate the path taken by a vehicle using only IMU data in conjunction with the knowledge of the position of the vehicle at a given time. Absolute position measurements can be provided for the positions of fixed sensors that are in range of the vehicle, several tens of meters for this discussion. But, fixed sensors and IMU devices with a range of few thousand meters are also within the scope of various embodiments. Lastly, for validation purposes only, a GPS sensor, compatible with an APM system, was used to record absolute positions of the vehicle during trips and to validate accuracy of the path reconstruction algorithm.

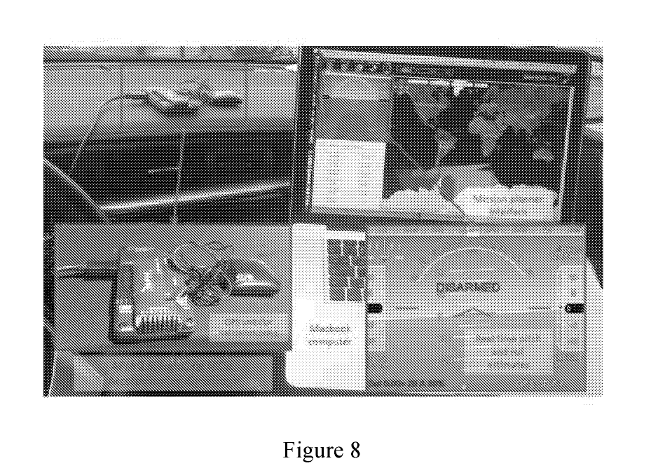

The exemplary device implementation, configured merely for data acquisition purposes, is depicted in FIG. 8. The exemplary implementation includes an APM v2.6 stably attached to the dashboard. The direct cosine matrix filter of the IMU device can be recalibrated by rotating the APM to various attitudes, ensuring that both the accelerometer and the gyroscope data. The software interface can be a customized version of the APM Mission Planner, which is open source software, such as Ardupilot. This can allow calibration and operation of the system, as well as allowing extraction of logged data directly from the APM to a computer for verification purposes.

The APM can log IMU data at various frequencies, for example 50 Hz, and can estimate attitude data, such as yaw, pitch, and roll angles, at a frequency such as 10 Hz. This can be advantageous since it can be a computationally expensive process. Lower frequencies of attitude data estimation processing need not be an issue in practice since typical vehicles do not experience high angular accelerations or drastic variations in acceleration. The system can be calibrated over multiple test drives, and the method can be carried out over multiple experiments to validate performance of the system. The total data acquisition for the implementation of FIG. 8 is approximately four minutes in duration, which at an average urban velocity of 10 km/h corresponds to around 500 meters between sensors or rather four fixed sensors per square kilometer.

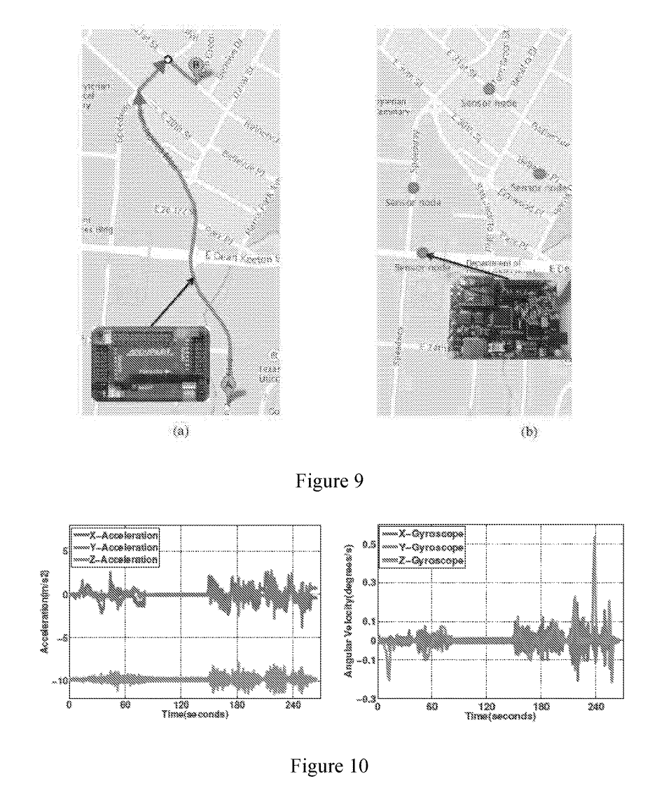

Trajectories obtained using the GPS validation data is shown in FIG. 9a, on a test drive in Austin, Tex. The route is not perfectly flat, particularly near its end (From A to B). Placement of the fixed wireless sensor network is shown in FIG. 9b. FIG. 10 shows raw data obtained from the accelerometer and gyroscope of the IMU during the four-minute trip.

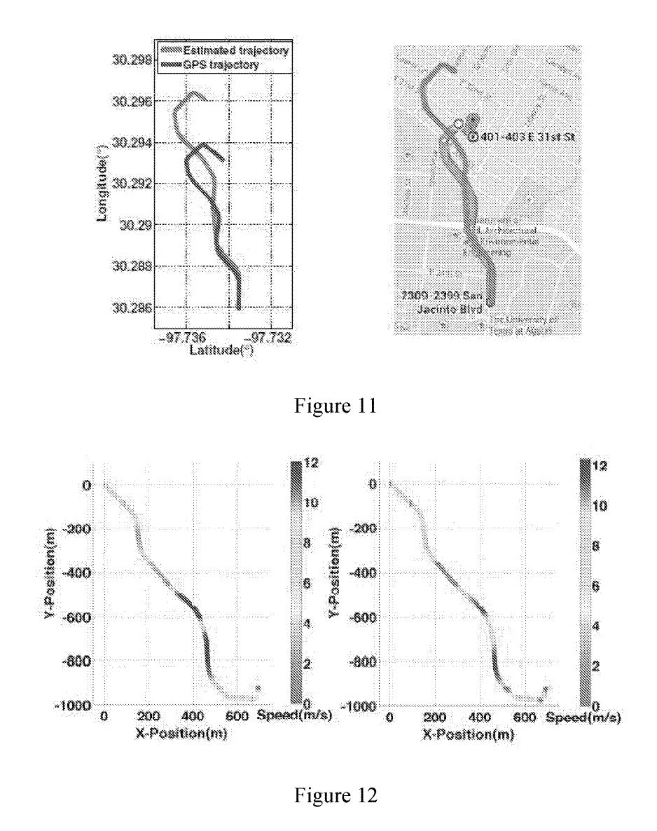

The dead reckoning algorithm can yield an estimated trajectory, which is plotted in FIG. 11 together with actual trajectory. Based on the trajectory reconstruction algorithm described herein, the estimated speed map can be computed, for example, using only the IMU data. The graph on the left of FIG. 11 shows an estimated trajectory using the dead reckoning algorithm compared to the GPS trajectory of the car trip in Austin, Tex. The graph on the right shows the estimated and true GPS plots over a local road network using Google Maps.

As can be seen from FIG. 11, the estimated trajectory using the IMU data only is not compatible with the urban road network. While the estimated trajectory captures the main features of the actual trajectory, it can exhibit increasing positioning error due to measurement uncertainty and integration errors. Nevertheless, knowledge of the road network structure can be used to reconstruct the actual vehicle path from noisy trajectory data. As discussed herein, piecewise linear approximation of the trajectory, which can have linear segments of given lengths, can be utilized. The lengths and heading changes between segments associated with the actual (linearized) trajectory is illustrated in Table 2. Data available to the fixed sensor beacon, e.g. final locations of the vehicle and piecewise linear approximations of the trajectory, can be considered to reconstruct actual trajectory. In the exemplary implementation, only the last five segments are considered for simplicity. The last four segments of the piecewise linear trajectory approximation can be compared to all other possible paths that would lead to the measured final position. A way to do this can be to construct a directed graph from local map data and computing all possible paths and routes to lead to the point from any point within a defined radius or area. Such a directed graph is constructed using the road network topology extracted from Google Maps. Based on this data and the map, 17 paths could lead to the destination point. The properties of these paths are summarized in Table 2. No absolute heading measurement data is available from the exemplary implementation. Thus, link parameters are their length and the headings change with respect to the previous link. The corresponding parameters can be computed for the links corresponding to the piecewise linear approximation of the trajectory of the vehicle. These parameters can be used to find the most likely path taken by the car. For this, a quadratic cost function can be used, defined by

$$Cost = {\sum }_{i = 1}^{4} {( {L}_{i} - {L}_{{DR}_{i}} )}^{2} + {\sum }_{i = 1}^{4} {( {H}_{i} - {H}_{{DR}_{i}} )}^{2} ,$$

where Lᵢ corresponds to the length of the i^{th} segment and Hᵢ corresponds to the heading change of the segment i with respect to the segment i−1. L_{DR}_{ᵢ} and H_{DR}_{ᵢ} are the length and heading change parameters that can be extracted from the trajectory reconstructed by dead reckoning algorithms discussed herein. As can be seen in Table 2, the path with the least cost is path 14, which corresponds to the actual path taken by the vehicle. System embodiments can be implemented by placing sensors at each area to receive IMU data and construct trajectory to identify previous routes taken to arrive to this point.

FIG. 12 compares measured data to a speed map generated by GPS data. The graph on the left shows the estimated speed map using a dead reckoning algorithm. The graph on the right of FIG. 12 compares the actual GPS speed map.

Table 2 also shows possible paths piecewise-linearized. The link parameters are their length in meters and their heading change in degrees, where a positive heading change indicates a right turn and a negative heading change indicates a left turn.

TABLE 2

| | Leg1 | | Leg2 | | Leg3 | | Leg4 | | Leg5 | | Cost × |
|---|---|---|---|---|---|---|---|---|---|---|---|
| Path No. | Length | Heading | Length | Heading | Length | Heading | Length | Heading | Length | Heading | (10⁵) |
| 1 | 98 | N/A | 110 | −90 | 200 | 90 | >150 | −15 | — | — | 1.93 |
| 2 | 300 | N/A | 10 | −90 | >150 | 90 | — | — | — | — | 2.86 |
| 3 | 260 | N/A | 140 | 90 | 60 | −90 | 10 | −90 | — | — | 2.68 |
| 4 | 180 | N/A | 60 | 90 | 50 | 30 | 190 | −30 | 150 | −90 | 1.37 |
| 5 | 180 | N/A | 80 | 80 | 70 | 30 | 250 | −30 | 65 | −90 | 1.81 |
| 6 | 98 | N/A | 70 | 110 | 60 | −30 | 70 | 20 | 45 | −100 | 2.15 |
| 7 | 110 | N/A | 350 | −110 | 130 | −90 | 68 | 90 | — | — | 2.42 |
| 8 | 110 | N/A | 450 | −110 | 94 | 90 | 48 | −90 | — | — | 3.01 |
| 9 | 110 | N/A | 150 | −110 | 98 | 90 | 150 | −90 | — | — | 1.85 |
| 10 | 110 | N/A | 150 | −110 | 200 | 90 | 130 | −90 | — | — | 1.97 |
| 11 | 110 | N/A | 150 | −110 | 300 | 90 | 89 | −90 | — | — | 2.34 |
| 12 | 110 | N/A | 210 | −20 | 30 | −90 | 150 | 90 | — | — | 1.97 |
| 13 | 110 | N/A | 110 | 80 | 90 | −20 | 190 | −90 | 43 | 90 | 1.66 |
| 14 | 96 | N/A | 110 | −90 | 100 | −45 | 150 | −30 | 100 | 30 | 0.93* |
| 15 | 96 | N/A | 200 | −90 | 250 | −45 | — | — | — | — | 2.28 |
| 16 | 96 | N/A | 200 | −90 | 100 | −45 | 270 | 90 | — | — | 1.86 |
| 17 | 96 | N/A | 200 | −90 | 100 | −45 | 110 | 90 | 130 | −90 | 1.17 |
| DR | 87 | N/A | 142 | −96 | 102 | −45 | 200 | −38 | 400 | 40 | — |

Present embodiments can include a system for probe sensing, e.g. in urban environments, that offers several advantages over current, satellite-based systems. For example, they need not rely on satellite positioning data and can therefore be immune to multi-path effects, which severely reduce accuracy of positioning in cities. They can also be implemented less expensively than known systems, even after factoring in the cost of fixed sensor nodes. This is particularly true when compared to GPS-based systems, where GPS chips typically cost on the order often times the cost of IMU chips. For example, GPS chips can currently be obtained for approximately $30 per chip whereas IMU chips can be obtain for approximately $3 per chip.

Present embodiments can also exhibit a high degree of accuracy, at least substantially comparable to GPS-based systems, when utilized conjunction with, for example, fixed wireless sensor systems that can periodically update absolute positions. Moreover, the fixed-sensor system can be integrated with additional traffic and/or weather sensing functionality. Another advantage of present embodiment can be achieved in very dense urban environments with tunnels, underpasses, and overpasses, while not providing absolute location information, which can greatly reduce the risk of privacy intrusion.

Embodiments can improve performance and accuracy of both the trajectory estimation and the path reconstruction by integrating pitch and roll patterns experienced by a vehicle, which translate the slope of the road and can be very useful in determining the actual path of the vehicle. This can improve path reconstruction accuracy and the speed estimation.

Embodiments can be implemented to detect traffic behaviors, such congestion, stop-and-go waves, intentional stops, stops caused by a traffic light, etc., and can thus send more accurate traffic data to servers. System embodiments can process probe data to, e.g., monitor road conditions in general and/or determine the presence of emergency conditions such as road debris and flooding. This aggregated data can also be used to remove outliers at the source, which is not done with GPS-based systems since the sampling rate and positioning accuracy of GPSs is generally too low. In the context of urban traffic sensing, outliers can be highly problematic to traffic analysis since they send false measurements of the conditions to the traffic estimation servers, which would typically require a much larger number of probes than what would theoretically be needed for congestion monitoring. Although present embodiments are primarily discussed as an alternative to GPS-based systems, they can nonetheless be integrated with GPS-based systems, for example, to augment data analysis, such as in sparse traffic or rural areas. A goal of preferred embodiments is to monitor more efficiently and reliably traffic, particularly in areas where GPS sensing alone is not efficient or is prone to errors due to, e.g., uncertainty in positioning.

IMU device embodiments can include an accelerometer, a gyroscope, and optionally a magnetometer. An IMU device can further include or be connected to a microprocessor, a transceiver, and an absolute positioning device, e.g. a GPS device. The absolute positioning system is optional and can be replaced with, for example, dead reckoning and/or periodic positioning. For example, the device can utilize triangulation and/or trilateration of the transceiver by a network of fixed beacons. The IMU device can be positioned within or on a vehicle, such as a car, a truck, an SUV, a lorry, or marine vehicles such as boats and/or ships for use in ports, canals, locks, etc.

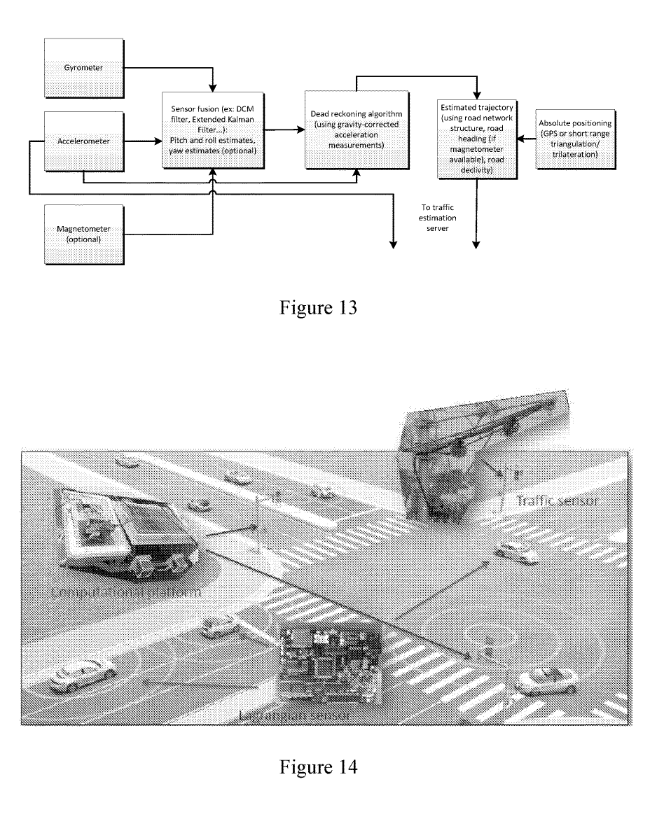

FIG. 13 illustrates an exemplary system embodiment. The IMU device includes a gyroscope and an accelerometer. Optionally, the IMU device can include a magnetometer. The gyroscope, accelerometer, and optional magnetometer can be connected to a processor for sensor data fusion, for example via DCM filtering and/or extended Kalman filtering, which can be performed within the IMU device processor or by system network nodes. Processors can perform pitch, roll, and/or yaw estimates. Processors can also perform dead reckoning based on, for example, gravity-corrected acceleration measurements as described herein. Further, processors can also estimate trajectories, for example by utilizing road network structure, road heading, and/or road declivity. As shown in FIG. 13, absolute positioning can optionally be performed, for example from GPS data and/or short range triangulation/trilateration. Computed data, performed by IMU devices and/or network nodes, can be sent to one or more traffic estimation servers.

FIG. 14 depicts an exemplary system embodiment. System embodiments can be implemented having wireless probe-sensing nodes, wireless traffic- and/or environment-sensing nodes, and/or wireless sensor networks. For convenience and/or cost savings, nodes can be disposed on pre-existing structures, such as traffic lights as shown in the figure on buildings and other structures. Probe-sensing nodes can be integrated with or separate from traffic- and/or environment-sensing nodes. For example, the system embodiment of FIG. 14 depicts probe vehicles containing IMU devices, marked as Lagrangian Sensors, that can transmit trajectory data to probe-sensing nodes, marked as Computational Platforms. The probe-sensing nodes are shown in close proximity for illustrative purposes, and it should be understood by a person having ordinary skill in the art that the nodes can disposed much farther apart, e.g. 100 m, 500 m, 1000 m, etc. The wireless traffic- and/or environment-sensing nodes, as depicted in in FIG. 14, can integrate sensors for detecting weather conditions such as temperature, rain, and flooding on the roadway near the node, for example by means of acoustic sensors, infrared sensors, radio sensors, microwave sensors, spread-spectrum sensors, and/or other sensors.

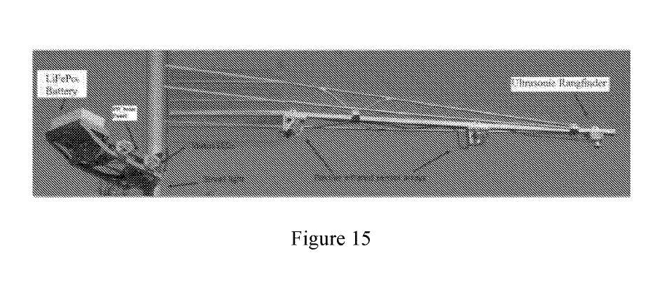

FIG. 15 further illustrates a traffic- and environment-sensing node of an exemplary system embodiment. Such nodes can incorporate passive infrared sensors for detecting vehicles. The nodes can also or alternatively incorporate an ultrasonic rangefinder for detecting and/or measuring water levels on the nearby roadway. The node can be supplied with electrical power by battery cells, shown as LiFePO₄ in the figure but other cells can be utilized. The cells are charged by a solar panel. The solar panel can, if desired, utilize structures and/or firmware/software for detecting the incident angle of the Sun's rays on the panel and then orient the solar panel to maximize solar yield. The firmware/software for maximizing solar yield can be integrated with or independent from the remainder of the node. The probe-sensing nodes and traffic- and/or environment-sensing nodes are shown in FIGS. 14 and 15 as separate nodes for illustrative purposes, and it should be understood by a person having ordinary skill in the art that the two node types can integrated into single multi-functional nodes, which are within the scope of described embodiments.

The nodes can be powered by traditional hard-wiring to a utility power supply and/or by solar panels or wind turbines. In some embodiments, a wireless (mesh) sensor network can collect vehicle data and exchange the data among nodes of the network as part of a data acquisition process. The nodes can communicate with nearby nodes forming an ad hoc network. The nodes can then communicate collected data to a central data collection site, such as a backend server system. The central data collection site can process local traffic and/or flood conditions relayed by the network. Global traffic conditions can also be estimated using traffic flow models and origin-destination models to create a map of current and future traffic flow conditions. Global flood conditions can also be forecasted using current conditions, meteorological data and/or sewer models, or any algorithm that simulates floods. These can include, e.g. hydrodynamical models based on finite element methods, which can include variations (mesh refinement, model reduction, etc.). To forecast floods, standard estimation methods may be used for distributed parameter systems such as ensemble Kalman filtering and/or particle filtering. Standard estimation methods may be combined with additional flood simulation algorithms.

Certain embodiments can utilize a decentralized routing scheme to optimize energy in solar- or battery-powered wireless nodes. The network can also be utilized for distributed computing, which can be facilitated via small, high performance processors such as, for example, the Cortex M4 microprocessor.

Another advantageous implementation of certain embodiments includes long-term sensing applications such as, for example, monitoring environmental conditions including precipitation, flooding, temperature, freezing, etc., and/or such as monitoring traffic and roadway conditions. Long-term sensing applications can be facilitated through the use of self-reset circuitry within nodes of the sensor network, and can be further facilitated through the use of programmable watchdog functionalities that allow an unresponsive node to be automatically reset.

The embodiments may take the form of a hardware embodiment, a software embodiment, or an embodiment combining software and hardware. In one embodiment, the present invention takes the form of a computer-program product that includes computer-useable instructions embodied on one or more computer-readable media.

The various integrated techniques, methods, and systems described herein can be implemented in part or in whole using computer-based systems and methods. Additionally, computer-based systems and methods can be used to augment or enhance the functionality described herein, increase the speed at which the functions can be performed, and provide additional features and aspects as a part of or in addition to those described elsewhere in this document. Various computer-based systems, methods and implementations in accordance with the described technology are presented below.

Embodiments may include a general-purpose computer and can have an internal or external memory for storing data and programs such as an operating system (e.g., DOS, Windows 2000™, Windows XP™, Windows NT™, OS/2, OS X, Android OS, UNIX or Linux) and one or more application programs. Examples of application programs include computer programs implementing the techniques described herein for lyric and multimedia customization, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP). One or more of the application programs can be installed on the internal or external storage of the general-purpose computer. Alternatively, in another embodiment, application programs can be externally stored in or performed by one or more device(s) external to the general-purpose computer.

The general-purpose computer may include a central processing unit (CPU) for executing instructions in response to commands, and a communication device for sending and receiving data. One example of the communication device is a modem. Other examples include a transceiver, a communication card, an antenna, a network adapter, or some other mechanism capable of transmitting and receiving data over a communications link through a wired or wireless data pathway.

The general-purpose computer may also include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices may themselves include the functionality of the general-purpose computer. For example, the mobile phone or the PDA may include computing and networking capabilities and function as a general purpose computer by accessing a network and communicating with other computer systems. Examples of a network that can be utilized to implement various embodiments include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link can include communication pathways that enable communications through one or more networks.

In one implementation, a processor-based system of the general-purpose computer can include a main memory, preferably random access memory (RAM), and can also include a secondary memory. The secondary memory can include, for example, a hard disk drive or a removable storage drive, representing a floppy disk drive, a magnetic tape drive, an optical disk drive (Blu-Ray, DVD, CD drive), magnetic tape, paper tape, punched cards, standalone RAM disks, Iomega Zip drive, etc. The removable storage drive can read from or write to a removable storage medium. A removable storage medium can include a floppy disk, magnetic tape, optical disk (Blu-Ray disc, DVD, CD) a memory card (CompactFlash card, Secure Digital card, Memory Stick), paper data storage (punched card, punched tape), etc., which can be removed from the storage drive used to perform read and write operations. As will be appreciated, the removable storage medium can include computer software or data.

In alternative embodiments, the secondary memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, a network can include a communications interface that allows software and data to be transferred between client devices, central servers, and other components. Examples of communications interfaces can include a modem, a network interface (such as, for example, an Ethernet card), a communications port, and a PCMCIA slot and card. Software and data transferred via a communications interface may be in the form of signals, which can be electronic, electromagnetic, optical or other signals capable of being received by a communications interface. These signals may be provided to a communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer readable medium” are generally used to refer to media such as a removable storage device, a disk capable of installation in a disk drive, and signals on a channel. These computer program products may provide software or program instructions to a computer system.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media include computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, DVD, holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

In an embodiment where the elements are implemented using software, the software can be stored in, or transmitted via, a computer program product and loaded into a computer system using, for example, a removable storage drive, hard drive or communications interface. The control logic (software), when executed by the processor, may cause the processor to perform the functions of the techniques described herein.

In another embodiment, the elements may be implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements may be implanted using a combination of both hardware and software.

In another embodiment, the computer-based methods can be accessed or implemented over the World Wide Web by providing access via a Web Page to the methods described herein. Accordingly, the Web Page may be identified by a Universal Resource Locator (URL). The URL may denote both a server and a particular file or page on the server.

Each of the following references is hereby incorporated by reference in its entirety.

Abdelkader, M., M. Shaqura, C. G Claudel, and W. Gueaieb, A UAV based system for real time flash flood monitoring in desert environments using Lagrangian microsensors. In Unmanned Aircraft Systems (ICUAS), 2013 International Conference on, IEEE, 2013, pp. 25-34.

Bachrach, A., S. Prentice, R. He, and N. Roy, RANGE—Robust autonomous navigation in GPS-denied environments. Journal of Field Robotics, Vol. 28, No. 5, 2011, pp. 644-666.

Barequet, G and M. Sharir, Piecewise-linear interpolation between polygonal slices. Computer vision and image understanding, Vol. 63, No. 2, 1996, pp. 251-272.

Canepa, E., E. Odat, A. Dehwah, M. Mousa, J. Jiang, and C. Claudel, A Sensor Network Architecture for Urban Traffic State Estimation with Mixed Eulerian/Lagrangian Sensing Based on Distributed Computing. In Architecture of Computing Systems—ARCS 2014, Springer, 2014, pp. 147-158.

Chen, W., Z. Li, M. Yu, and Y. Chen, Effects of sensor errors on the performance of map matching. Journal of Navigation, Vol. 58, No. 02, 2005, pp. 273-282.

Coleri, S., S. Y. Cheung, and P. Varaiya, Sensor networks for monitoring traffic. In Allerton conference on Communication, Control and Computing, 2004, pp. 32-40.

Fuke, Y. and E. Krotkov, Dead reckoning for a lunar rover on uneven terrain. In Robotics and Automation, 1996. Proceedings, 1996 IEEE International Conference on, IEEE, 1996, Vol. 1, pp. 411-416.

Gustafsson, F., F. Gunnarsson, N. Bergman, U. Forssell, J. Jansson, R. Karlsson, and P.-J. Nordlund, Particle filters for positioning, navigation, and tracking. Signal Processing, IEEE Transactions on, Vol. 50, No. 2, 2002, pp. 425-437.

Herrera, J. C., D. B. Work, R. Herring, X. J. Ban, Q. Jacobson, and A. M. Bayen, Evaluation of traffic data obtained via GPS-enabled mobile phones: The Mobile Century field experiment. Transportation Research Part C: Emerging Technologies, Vol. 18, No. 4, 2010, pp. 568-583.

iNemo inertial module: 3D accelerometer, 3D gyroscope, 3D magnetometer. ST, 2013.

Jiang, J. and C. Claudel, A wireless computational platform for distributed computing based traffic monitoring involving mixed Eulerian-Lagrangian sensing. In Industrial Embedded Systems (SIES), 2018 8th IEEE International Symposium on, IEEE, 2013, pp. 232-239.

Jimenez, A., F. Seco, C. Prieto, and J. Guevara, A comparison of pedestrian dead-reckoning algorithms using a low-cost MEMS IMU. In Intelligent Signal Processing, 2009. WISP 2009. IEEE International Symposium on, IEEE, 2009, pp. 37-42.

Kim, S. E., Performance comparison of loop/piezo and ultrasonic sensor-based traffic detection systems for collecting individual vehicle information. In Towards the New Horizon Together. Proceedings of The 5th world congress on Intelligent Transport System, held 12-16 Oct. 1998, Seoul, Korea. Paper No. 4083.

Lee, B. N. H. W., S., Development of the Portable Standard System for the Vehicle Detectors. In KSCE J. Civil Eng., 2006, pp. 353-359.

Mohan, P., V. N. Padmanabhan, and R. Ramjee, Nericell: rich monitoring of road and traffic conditions using mobile smartphones. In Proceedings of the 6th ACM conference on Embedded network sensor systems, ACM, 2008, pp. 323-336.

Ojeda, L. and J. Borenstein, Personal Dead-reckoning System for GPS-denied Environments. In Safety, Security and Rescue Robotics, 2007. SSRR 2007. IEEE International Workshop on, 2007, pp. 1-6.

Premerlani, W. and P. Bizard, Direction cosine matrix IMU: Theory. DIY Drones (2009). Accessed online via http site diydrones.com/profiles/blogs/dcm-imu-theory-first-draft?id=705844.

Schrank, D., T. Lomax, and S. Turner, TTI's 2010 urban mobility report powered by INRIX traffic data. Texas Transportation Institute, The Texas A&M University System, Vol. 17, 2010.

Sharafsaleh, A., Commercially-off-the-Shelf (COTS) and Emerging Technologies Sensor Testing and Evaluation. California PATH Program, Institute of Transportation Studies, University of California at Berkeley, 2006.

Sheik Mohammed Ali, S., B. George, L. Vanajakshi, V. Jayashankar, and V. Jagadeesh Kumar, A multiple loop vehicle detection system for heterogeneous and lane-less traffic. In Instrumentation and Measurement Technology Conference (I2MTC), 2011 IEEE, IEEE, 2011, pp. 1-5.

Wan, S. and E. Foxlin, Improved pedestrian navigation based on drift-reduced MEMS IMU chip. In Proceedings of the 2010 International Technical Meeting of The Institute of Navigation, 2001, pp. 220-229.

Weiss, S., D. Scaramuzza, and R. Siegwart, Monocular-SLAM-based navigation for autonomous micro helicopters in GPS-denied environments. Journal of Field Robotics, Vol. 28, No. 6,2011, pp. 854-874.

Work, D. and A. Bayen, Impacts of the mobile internet on transportation cyberphysical systems: traffic monitoring using smartphones. In National Workshop for Research on High-Confidence Transportation Cyber-Physical Systems: Automotive, Aviation, & Rail, 2008, pp. 18-20.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

1. A Lagrangian inertial measurement unit system, comprising:
one or more inertial measurement units, each of the inertial measurement units being attached to a vehicle and comprising:
a wireless transmitter and a processor connected to an accelerometer configured to measure linear accelerations of the vehicle and communicate a measured linear acceleration to the processor and to a gyroscope configured to measure rotational accelerations of the vehicle and communicate a measured rotational acceleration to the processor,
wherein the processor includes a direction cosine matrix complementary filter and is configured to output an estimated vehicle speed and an estimated vehicle attitude,
wherein the wireless transmitter is configured to wirelessly transmit the estimated vehicle speed and the estimated vehicle attitude;
a plurality of wireless sensor nodes, each of the plurality of wireless sensor nodes comprising:
a microcontroller platform and a node processor configured to estimate a vehicle trajectory based on the estimated vehicle speed and on the estimated vehicle attitude and is further configured to communicate an estimated vehicle trajectory to the transceiver,
a transceiver configured to receive the estimated vehicle speed and the estimated vehicle attitude and communicate the estimated vehicle speed and the estimated vehicle attitude to the node processor, and
wherein the transceiver is further configured to transmit the estimated vehicle trajectory to other wireless sensor nodes and is further configured to receive other estimated vehicle trajectories from the other wireless sensor nodes.

2. The system of claim 1, wherein the processor is further configured to output compressed data based on the estimated vehicle speed and on the estimated vehicle attitude.

3. The system of claim 2, wherein the processor estimates the estimated vehicle speed and the estimated vehicle attitude via a piecewise linear trajectory approximation of the measured linear acceleration and of the measured rotational acceleration.

4. The system of claim 1, wherein the plurality of wireless sensor nodes is configured to associate location fix data with the estimated vehicle trajectory.

5. The system of claim 4, wherein the Lagrangian inertial measurement unit system is configured to geographically map a traffic condition based on the location fix data and the estimated vehicle trajectory.

6. A Lagrangian inertial measurement unit, comprising: a processor integrating a direction cosine matrix;
an accelerometer configured to measure linear accelerations of a vehicle and to communicate a measured linear acceleration to the processor;
a gyroscope configured to measure rotational accelerations of the vehicle and to communicate a measured rotational acceleration to the processor;
wherein the processor and is configured to calculate an estimated vehicle speed and an estimated vehicle attitude; and
a wireless transmitter configured to wirelessly transmit the estimated vehicle speed and the estimated vehicle attitude.

7. The Lagrangian inertial measurement unit of claim 6, wherein the processor is further configured to calculate compressed data based on the measured vehicle speed and the measured vehicle attitude via a piecewise linear trajectory approximation subcomponent.

8. The Lagrangian inertial measurement unit of claim 7, further comprising a plurality of wireless sensor nodes, wherein each of the plurality of wireless sensor nodes comprises a microcontroller platform, a node processor, and a transceiver.

9. The Lagrangian inertial measurement unit of claim 8, wherein the transceiver is configured to receive the compressed data and communicate the compressed data to the node processor, and wherein the node processor is configured to estimate a vehicle trajectory based on the compressed data

10. The Lagrangian inertial measurement unit of claim 9, wherein the transceiver is further configured to transmit the estimated vehicle trajectory to other wireless sensor nodes of the plurality of wireless sensor nodes and to receive other estimated vehicle trajectories from the other wireless sensor nodes.

11. The Lagrangian inertial measurement unit of claim 6, further comprising a plurality of wireless sensor nodes, wherein each of the plurality of wireless sensor nodes comprises a microcontroller platform, a node processor, and a transceiver.

12. A Lagrangian inertial measurement method for determining traffic conditions, comprising:
measuring with an accelerometer linear accelerations of a vehicle;
measuring with a gyroscope rotational accelerations of the vehicle
filtering with a direction cosine matrix complementary filter the measured linear accelerations and the measured rotational accelerations to obtain filtered speed and attitude data;
estimating a vehicle speed and a vehicle attitude based on the filtered speed and attitude data;
wirelessly transmitting the estimated vehicle speed and the estimated vehicle attitude to a fixed node of a wireless sensor network; and
calculating an estimated vehicle path.

13. The method of claim 12, wherein calculating the estimated vehicle path further comprises performing a periodic heading fix.

14. The method of claim 12, wherein calculating the estimated vehicle path further comprises performing a periodic map-matching to reconstruct vehicle trajectory.

15. The method of claim 13, further comprising performing a piecewise linear approximation of the estimated vehicle path.

16. The method of claim 15, further comprising an optimization of the estimated vehicle path to determine an actual vehicle path.

17. The method of claim 12, wherein a transceiver of the fixed node receives the estimated vehicle speed and the estimated vehicle attitude and communicates the estimated vehicle speed and the estimated vehicle attitude to a node processor.

18. The method of claim 17, wherein the node processor estimates a vehicle trajectory based on the estimated vehicle speed and on the estimated vehicle attitude.

19. The method of claim 18, wherein the node processor communicates an estimated vehicle trajectory to the transceiver, and the transceiver transmits the estimated vehicle trajectory to other wireless sensor nodes of the wireless sensor network.
